(19) United States
(12) Patent Application Publication
(10) Pub. No.: US 2013/0301292 A1
(43) Pub. Date: Nov. 14, 2013

(54) BLACK LIGHT COMB

(71) Applicant: Carlos Jose Albaladejo Jimenez, Madrid (ES)

(72) Inventor: Carlos Jose Albaladejo Jimenez, Madrid (ES)

(21) Appl. No.: 13/946,501

(22) Filed: Jul. 19, 2013

Related U.S. Application Data
(63) Continuation-in-part of application No. 13/147,756, filed on Sep. 15, 2011, now Pat. No. 8,517,557.

(30) Foreign Application Priority Data
Feb. 9, 2009 (ES) 200900213

(51) Int. Cl. F21V 33/00; F21L 4/02

(52) U.S. Cl. CPC F21V 33/0064; F21L 4/027
USPC 362/555

(57) ABSTRACT

A black light comb is provided that is designed to be easily held when used to examine, clean, remove and/or eliminate nits, lice, eggs or nymphs, fleas, bedbugs or ticks on the scalp of an affected person or animal or from environments in which remains may be found from having been in contact with the affected person or animal. The black light comb includes a body having a watertight compartment for containing electric batteries. The body further includes a guide from which a comb structure is projected, formed by a plurality of curved teeth made of a flexible material that conducts black light. The black light comb further includes a group of diodes emitting black light. The diodes are arranged in correspondence with the guide such that the plurality of teeth can be lit up by the group of diodes.

### CROSS-REFERENCE TO RELATED APPLICATION

This application is a continuation-in-part of U.S. patent application Ser. No. 13/147,756, filed Sep. 15, 2011, which is a National Stage Application of PCT Application No. PCT/ES2010/000051, filed Feb. 8, 2010, which claims priority to Spanish Application No. 200900213, filed Feb. 9, 2009; the disclosures of which are incorporated by reference herein in their entireties.

### BACKGROUND OF THE INVENTION

Given the large problem in society with outbreaks of lice, which, year after year, infect in particular the child population in schools, nurseries, parks, sports centers, places of study and leisure, in general, no pharmaceutical or chemical product is one hundred per cent effective in eradicating said outbreaks completely. Traditional pediculicides are permethrin, malathion and phenothrin based products and the most current, a dimethicone-based product. Several of these products are highly toxic and, as such, are not recommended, above all, for use on infants and very young children, who also experience this problem. In addition, these chemical insecticides are becoming less and less effective given the emergence of pockets of resistance and the increased resistance of lice.

Conventional solutions to lice problems are to clean the entire head of hair and attempt to precisely removal of all lice and each one of the lice and nits present on the infected person's head or animal's hair, for which visual location of any insect or nit that confirms that the hair is eyesight and many hours inspecting the child's head would be required.

Pediculicides are often accompanied by combs or lice combs that remove nits and lice, after treatment. Nonetheless, as there is no reliable way of checking removal of the insects and subsequent cleaning, it is quite possible that complete removal and disinfection has not been carried out, so that the infestation occurs over and over again, with the ensuing inconvenience in the individual's life.

Conventional devices for removing lice from human and animal hair include plastic and metal devices, micro-channelled or not, and even removable dual-tooth. Electric-sound lice combs are also used to emit a constant beep that cuts out on closing the circuit on locating a louse, but it proves very inefficient with nits.

### SUMMARY

At least one exemplary embodiment provides a black light comb comprising a body having a compartment for containing batteries.

The body further comprises a guide from which a comb structure projects. The comb structure comprises a plurality of teeth made of a flexible material that conducts black light.

Thee black light comb further comprising a group of diodes emitting black light which are arranged essentially in correspondence with the guide, such that the plurality of teeth can be lit up by the group of diodes. This way, the teeth are fully illuminated upon turning on the light comb. Therefore., when the room light is turned off every single insect or egg on the patient's head or on the animal's hair can be easily located if the light comb is turned on.

The teeth of the light comb are made of an elastic and/or flexible material, such that the teeth of the light comb are riot deformed when using. For example, the teeth are made of a plastic or optical fibre or silica material, polymeric material or any other material particularly sensitive to the transmission of light, such as some form of polyethylene. In this way, they will be fully lit up as if it were a fluorescent black light, which helps to perfectly see the nits which are white colored eggs, as well as the young lice or nymphs, which are very difficult to see as they are transparent, by facilitating their location and removal either humans or animals.

Also, there can be a small opening or recess on the handle in which there is a brush with curved, firm bristles built in, which allows for effectively brushing off the nits removed in each stroke. This cleaning brush is removable. The comb can be rinsed with water or some disinfectant for its easy cleaning.

The light comb is suitable for use in lice, nits, young lice or nymphs, fleas, bedbugs, ticks, etc.

To complete the description and in order to help to better understand the characteristics of the invention, accompanying the present specification herein are a set of drawings in whose figures the innovations and advantages of the black light lice comb, object of the invention, will be more easily understood.

### BRIEF DESCRIPTION OF THE DRAWINGS

FIG. 1 shows a side elevation view of a first exemplary embodiment of the light comb with built-in bristle brush.

FIG. 2 shows a plan view of the underside of the light comb of FIG. 1, showing the guide where the teeth are inserted.

FIG. 3 shows a front elevation view of the light comb of FIG. 1 viewed from its lamp's end, in which the black light LEDs incorporated therein can be seen.

FIG. 4 shows a rear elevation view of the light comb where the cavity for the battery device is located.

FIG. 5 shows a section view of the light comb showing the cavity where the batteries, LEDs and teeth are inserted.

FIGS. 6A-6D show a bottom perspective view of four various exemplary embodiments of the light comb.

FIG. 7 shows a perspective view of an ergonomic body/handle of the light comb shown in any of FIGS. 6A-6C.

FIG. 8A-8B show a side elevation view of an exemplary embodiment of the light comb teeth, for use in animals.

FIG. 9A-9B show a side elevation view of another exemplary embodiment of the light comb teeth, for use in animals.

FIG. 10 shows a side elevation view of another exemplary embodiment of the light comb teeth.

FIG. 11 shows a side elevation view of yet another exemplary embodiment of the light comb teeth.

FIGS. 12-13 show a perspective view of two exemplary embodiments of the light comb teeth, for use in animals.

### DESCRIPTION OF THE VARIOUS EMBODIMENTS

In view of the figures that follow, the basis of the success of the black light comb is the superconductivity of the black light through the teeth of the light comb. The material that is chosen for the light comb is a material having said superconducting properties of black light, such as for example, fibre optics or some type of polyethylene superconductor of light.

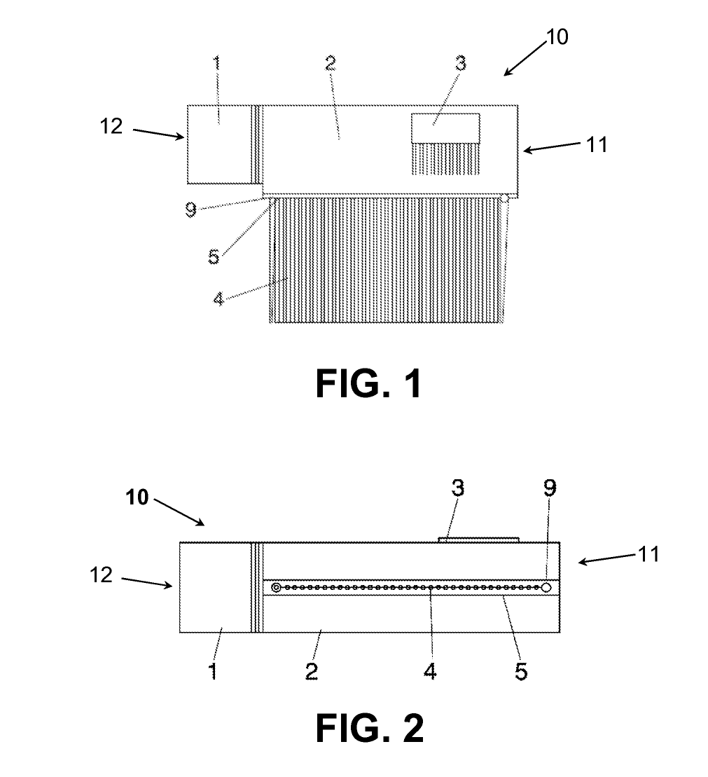

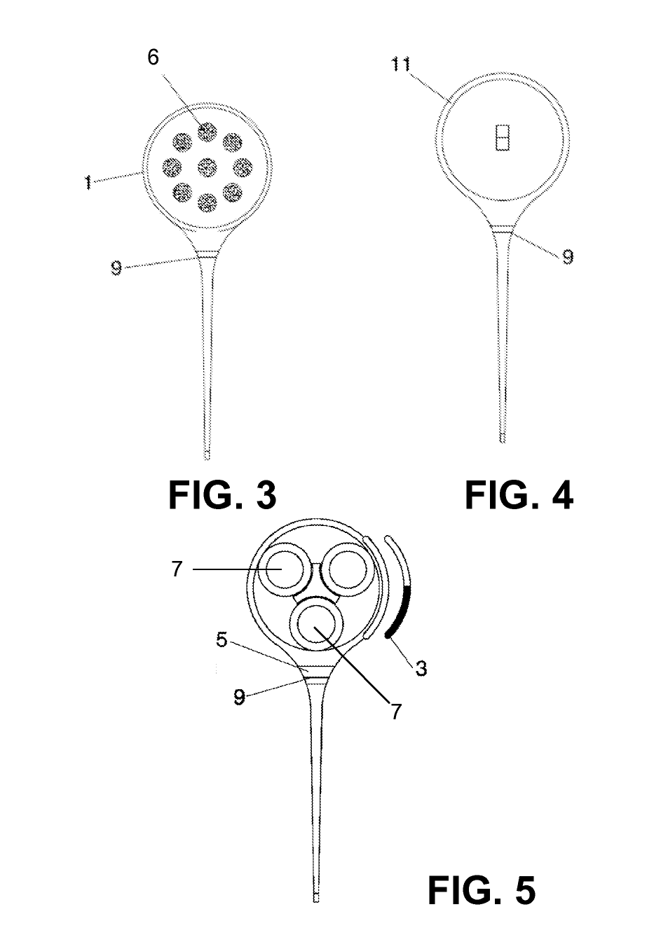

FIGS. 1-5 show a first exemplary embodiment a light comb 10, to remove lice and/or nits in humans.

This light comb 10 has a body 2 which also serves as handle and is circular in shape, such that it sits well in the hand of the individual using it and allowing it to be used from all angles on the head of the infested individual.

The light comb 10 has a trace lamp 1 located at one end of the handle 2, to allow its use without modifying the grip of the lice light comb 10, which facilitates handling and thereby the cleaning of the individual. This lamp 1 is located at one end 12 of the light comb 10 opposite to the end 11 where a watertight compartment containing electric batteries 7 is located. The lamp 4 contains a first group of diodes 6 that emit black light, and which is enclosed by means of a lens through which the light emitted by said diodes 6 is projected.

The light comb 10 also has a plurality of teeth 4, which are embedded on a plastic guide 9 located under a row of a second group of black light LEDs 5. In this embodiment the teeth 4 are fine and close together to carry out the lice and nit dragging function. The teeth 4 are made of a material conducting black light, such as fibre optics or some type of polyethylene superconducting light. This way, the plurality of teeth 4 can be lit up by this second group of diodes 5.

Embedded in a side of the body 2 there is a curved bristle brush 3 to facilitate cleaning the teeth 4 of the lice light comb 10.

As shown in FIG. 5, the light comb includes a switch 8 on a closing lid of the watertight compartment containing the batteries 7, by means of which the black light mode is operable in different modes.

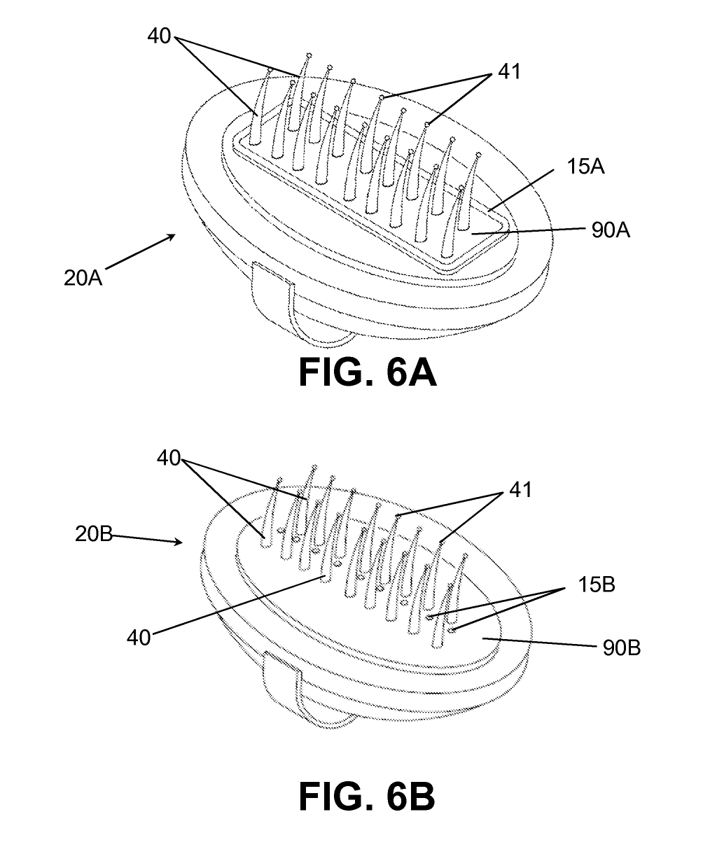

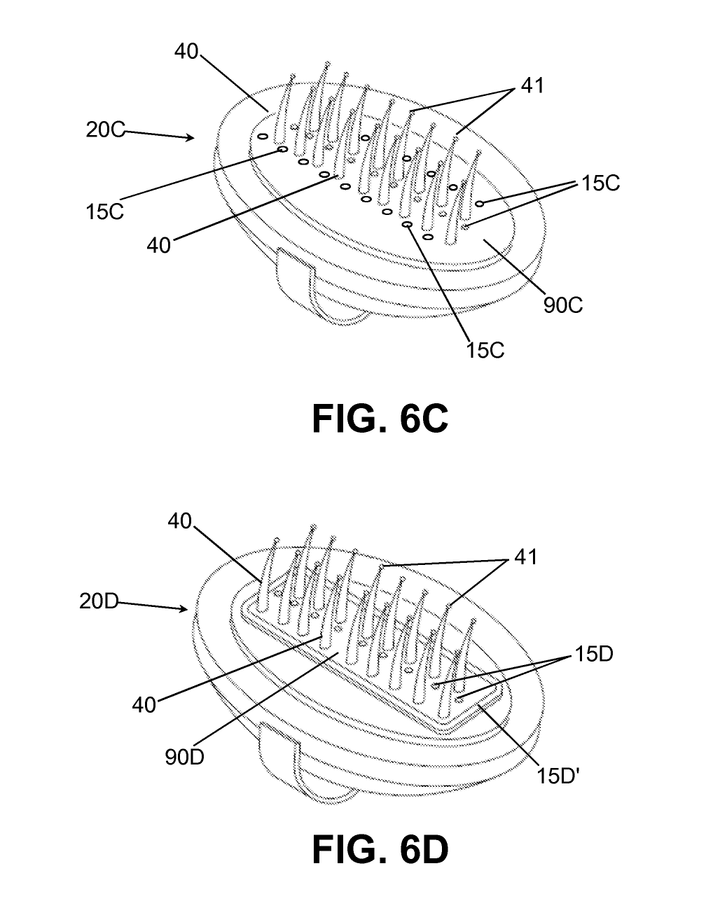

FIGS. 6A-6D show four exemplary embodiments of a light comb for use in animals. In all four cases the light comb 20 has a plurality of teeth 40. The plurality of teeth are formed to have a long and slim profile. The teeth 40 are about 5 or 6 centimeters long, for example, with a thin and rounded stem; they are made of a plastic material with some flexibility but lacking of a substantial tendency to deform in normal use. The plurality of teeth may further be straight, curved, or a combination of straight and curved. The embodiments shown have two rows of teeth, all teeth having the same length, but the light comb can also be provided with a different number of rows—one, two or three teeth rows—. In addition, the teeth in each row may have different alternate lengths.

The teeth 40 are provided with a rounded tip 41 so as to support the device onto the animal's skin without any risk of injuries.

This embodiment is especially suited for dog breeds such as St. Bernard, Alsatian, etc.

In the light comb 20A shown FIG. 6A the guide 90A supporting the teeth 40 structure has rectangular shape. The group of diodes are arranged around the plurality of teeth and covered or enclosed by a lens 15A.

In the light comb 20B of FIG. 6B the guide 90B has an oval shape. The diodes are arranged in a single row between the two rows of curved teeth 40, also covered by respective lenses 15B.

In the light comb 20C of FIG. 6C the diodes are arranged in three rows, enclosed by respective lenses 15C.

Finally the light comb 20D of FIG. 6D has a rectangular guide 90D. This light comb includes two groups of diodes: a first group of diodes is arranged in a single row between the two rows of curved teeth 40, and covered by a lens 15D, and a second group of diodes is arranged around the plurality of teeth and covered or enclosed by a lens 15D′.

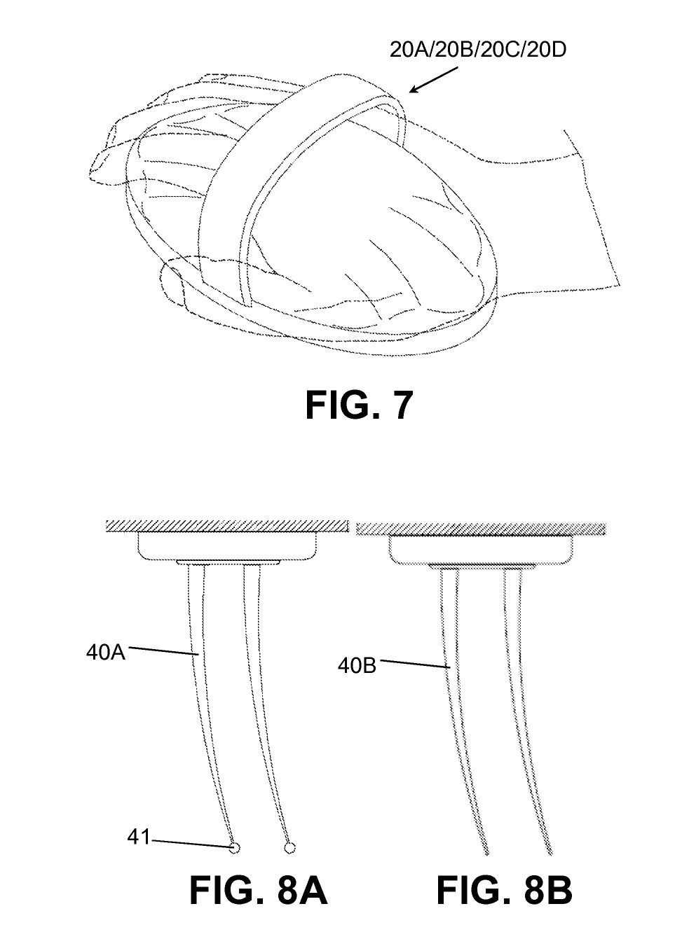

FIG. 7 shows a top view of the light comb 20A, 20B, 20C, 20D in any of FIGS. 6A-6D, showing its ergonomic handle.

FIG. 8A and 8B show a side elevation view of an exemplary embodiment of the light comb teeth 40A, 40B, respectively for use in animals. The tip 41 of the teeth 40A of FIG. 8A is round. The view shown in FIG. 8A could correspond to the light comb 20A, 20B, 20C, 20D shown in any of FIGS. 6A-6D.

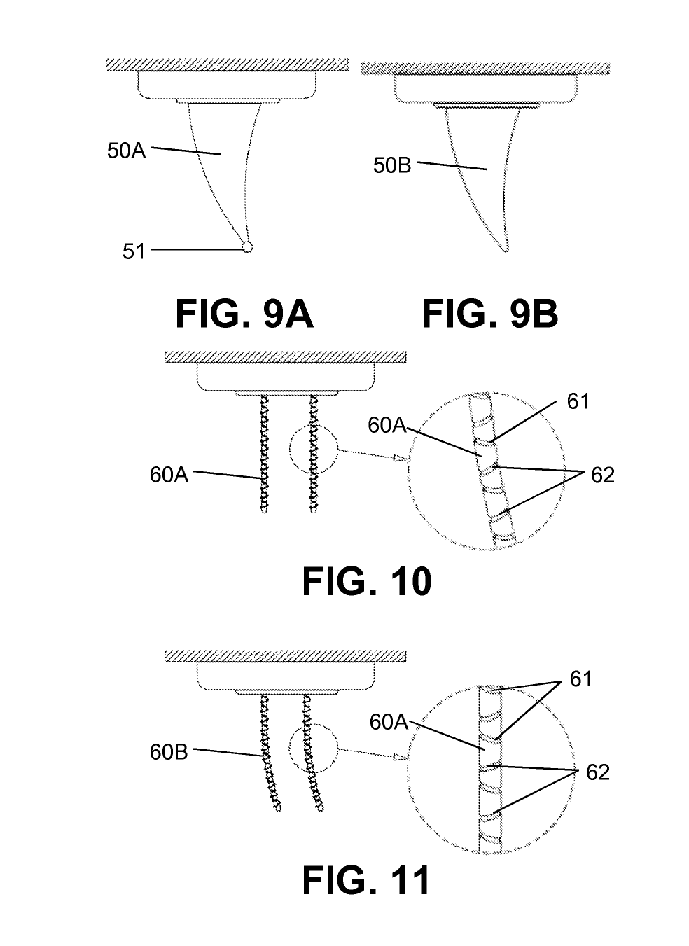

Alternatively and as shown in FIGS. 9A and 9B, the teeth 50A, 50B, respectively, can be short and wide, and also curved. The tip 51 of the teeth 50A of FIG. 9A is round.

In this embodiment the teeth 50A, 50B are about 3 centimeters long, for example, with a wide and substantially flat stem, having a shape like a shark tooth or a lion claw. In this case a single row of teeth 50 may be enough. These teeth 50 are particularly suited for the removal of ticks in dog breeds such as German shepherd, terrier, Labrador retriever, etc.

It is also possible that the same light comb contains both kinds of teeth, as shown in FIGS. 8 and 9, in any combination.

In the embodiments of the light comb shown in FIGS. 10 and 11, the teeth are metallic. The teeth 60A can be straight, as in FIG. 10, especially suitable for use in humans, or the teeth 60B can be slightly curved, as in FIG. 11, especially suitable for use in animals. In both cases the teeth 60A, 60B are micro-channeled. The micro-channel consists of a counter-clockwise helix 61 and a clockwise helix 62. It is also possible that the teeth are micro-channeled by means of only one of the two helices.

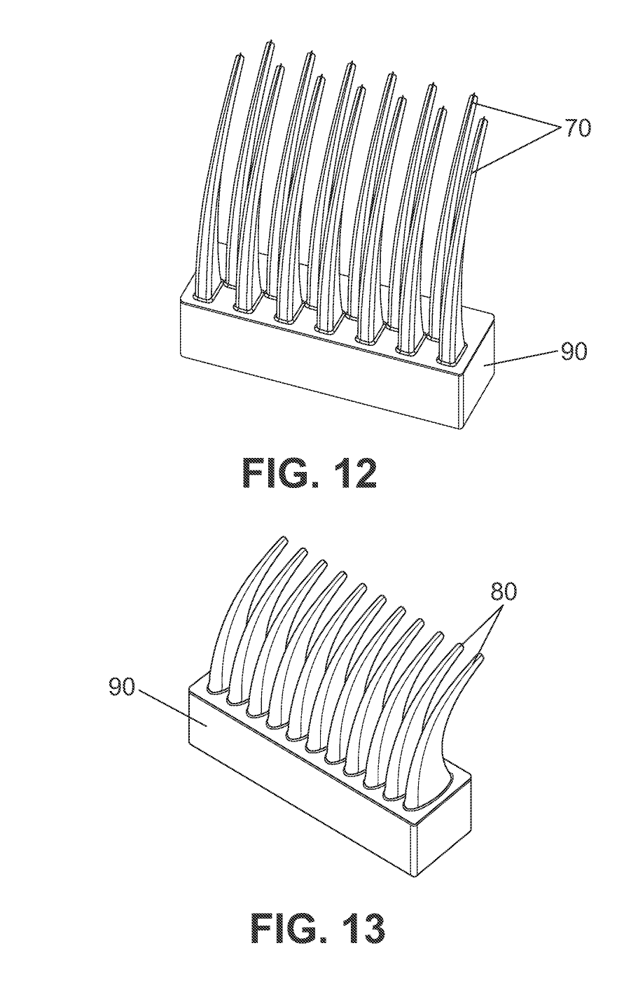

FIG. 12 shows another exemplary embodiment of the teeth in the light comb. The teeth. 70 in this embodiment are curved and polyhedral, having a rectangular cross section.

The teeth 80 in the embodiment of the light comb shown in FIG. 13 have an oval cross section.

In at least one exemplary embodiment, the light comb may have an ergonomic body which acts as a handle (see for example the light comb shown in FIGS. 6A-6C and 7), inside of which the batteries and the group of black light LEDs are located.

1. A black light comb designed so that it can be easily held when used to at least one of examine, clean, remove and eliminate nits, lice, eggs or nymphs, fleas, bedbugs or ticks on the scalp of at least one of an affected person, animal and from environments in which remains may be found from having been in contact with the affected person or animal, the black light comb comprising:
a body, the body including a watertight compartment configured to contain electric batteries;
the body further comprising a guide having a comb structure projecting therefrom, the comb structure including a plurality of curved teeth made of a flexible material that conducts black light; and
the black light comb further comprising a plurality of diodes configured to emit black light, the plurality of diodes arranged in correspondence with the guide such that the plurality of teeth are lit up in response to the black light emitted from the group of diodes.

2. The black light comb according to claim 1, wherein the teeth are long and slim.

3. The black light comb according to claim 1, wherein the teeth are short and wide.

4. The black light comb according to claim 1, wherein the teeth are disposed in substantially parallel rows.

5. The black light comb according to claim 1, wherein the teeth are ended with a rounded tip.

6. The black light comb according to claim 1, wherein the material of the teeth of the comb structure is chosen from a group including fibre optics and a polyethylene material having light conductivity.

7. The black light comb according to claim 1, wherein the plurality of LEDs are arranged in one or more rows.

8. The black light comb according to claim 1, wherein the plurality of LEDs are arranged surrounding the plurality of teeth.

9. The black light comb according to claim 1, further comprising a lens outwardly enclosing the plurality of diodes, such that the light emitted by said plurality of diodes is projected through the lens.

10. The black light comb according to claim 1, further comprising a bristle brush embedded on a side surface of the body, the bristle brush configured to clean the teeth of the lice comb.

11. The black light comb according to claim 1, further comprising a switch disposed on a closing lid of the watertight compartment, the switch configured to initiate different modes of which the black light comb.

12. A black light comb designed so that it can be easily held when used to at least one of examine, clean, remove and eliminate nits, lice, eggs or nymphs, fleas, bedbugs or ticks on the scalp of at least one of an affected person, animal and from environments in which remains may be found from having been in contact with the affected person or animal, the black light comb comprising:
a body having a watertight compartment configured to contain electric batteries;
the body further comprising a guide having a comb structure projecting therefrom, the comb structure including a plurality of teeth made of a material that conducts black light; and
the black light comb further comprising a plurality of diodes configured to emit black light, the plurality of diodes arranged in correspondence with the guide such that the plurality of teeth are lit up in response to the black light emitted from plurality of diodes, and wherein the teeth are metallic, and are at least one of straight and curved.

13. The black light comb according to claim 12, wherein the teeth are micro-channeled.

14. The black light comb of claim 13, wherein the micro-channeling of the teeth is engraved in counter-clockwise direction.

15. The black light comb of claim 12, wherein the teeth are curved.

16. The black light comb according to claim 12, wherein the plurality of LEDs are arranged in one or more rows.

17. The black light comb according to claim 12, wherein the plurality of LEDs are arranged surrounding the plurality of teeth.

18. The black light comb according to claim 12, further comprising a lens outwardly enclosing the plurality of diodes, such that the light emitted by said plurality of diodes is projected through the lens.
